(19) United States
(12) Patent Application Publication
(10) Pub. No.: US 2010/0040407 A1
(43) Pub. Date: Feb. 18, 2010

(54) BALL AND SOCKET JOINT

(76) Inventors: Martin Rechtien, Neuenkirchen- Vorden (DE); Holger Schichta, Lemforde (DE)

Correspondence Address: MCGLEW & TUTTLE, PC, P.O. BOX 9227, SCARBOROUGH STATION, SCARBOROUGH, NY, 10510-9227, US

(21) Appl. No.: 12/440,994

(22) PCT Filed: Sep. 10, 2007
(86) PCT No.: PCT/DE07/01585

§ 371 Date: Mar. 12, 2009

(30) Foreign Application Priority Data
Sep. 14, 2006 (DE) 10-2006-043-930.9

(51) Int. Cl. F16C 11/00; B23K 11/00

(52) U.S. Cl. 403/122; 219/117.1

(57) ABSTRACT

A ball and socket joint is provided for a vehicle. The ball and socket joint includes a housing (9), with a joint inner part (2), which is seated in the housing (9), extends from this and is mounted movably in the housing (9) with a bearing area (4) having a spherical surface or partial spherical surface (7) via the intermediary of a bearing shell (8). The housing has two housing parts (10, 12) meshing with one another, which are firmly connected to one another by means of at least one welded connection (19, 20), wherein the two housing parts (10, 12) are braced against one another in the radial direction to form a press fit.

### CROSS REFERENCE TO RELATED APPLICATIONS

This application is a United States National Phase application of International Application PCT/DE2007/001585 and claims the benefit of priority under 35 U.S.C. §119 of German Patent Application DE 10 2006 043 930.9 filed Sep. 14, 2006, the entire contents of which are incorporated herein by reference.

### FIELD OF THE INVENTION

The present invention pertains to a ball and socket joint for a vehicle, with a housing, with a joint inner part, which is seated in the housing, extends from same and is mounted movably with a bearing area having a spherical surface or a partial spherical surface via the intermediary of a bearing shell in the housing, which has two housing parts, which mesh with one another and which are firmly connected to one another by means of at least one welded connection. The present invention pertains, furthermore, to a process for manufacturing such a ball and socket joint.

### BACKGROUND OF THE INVENTION

Such ball and socket joints are known from the state of the art. DE 197 56 984 A1 discloses, e.g., a ball and socket joint with a bearing shell, which receives a ball head of a pivot pin on the inside and which is supported in a housing, and with a closing element, which lies on the bearing shell on the outside and by means of which the bearing shell can be prestressed in relation to the housing and the ball head. The closing element can be guided displaceably in an axial prestressing direction while pressure is admitted to the bearing shell at the housing and can be fixed in any desired position by welding. The outer circumferential surface of the closing element can be provided with sawtooth-like or triangular projections.

DE 10 2004 040 412 A1 discloses a ball sleeve joint, comprising a joint housing comprising two joint housing halves and a ball sleeve provided with a rounded bearing surface, wherein the bearing surface is received in a bearing shell, which is manufactured from an elastic plastic, and is fixed in a recess of the joint housing. The two housing halves are pressed together in the direction of the central longitudinal axis of the ball sleeve joint with defined pressing forces and kept together by means of a welded connection. In particular, one of the housing halves is pushed into the other housing half. On its outer surface, the bearing shell may have an extending holding projection, which meshes with a corresponding depression of the housing. Furthermore, the centers of the ball radii of the bearing surface and of the recess of the joint housing may be displaced prior to the application of the pressing forces in relation to one another in the direction of the central longitudinal axis.

There is a risk in the prior-art ball and socket joints that the bearing shell is thermally overloaded by the welding, which may lead to a reduction of the service life of the ball and socket joint.

### SUMMARY OF THE INVENTION

Based on this state of the art, the basic object of the present invention is to reduce the risk of thermal overload on the bearing shell.

The ball and socket joint according to the present invention for a vehicle, especially a motor vehicle, has a housing and a joint inner part, which is seated in the housing, extends out of same and is mounted movably, especially rotatably and/or pivotably in the housing with a bearing area comprising a spherical surface or partial spherical surface via the intermediary of a bearing shell, and which has two mutually meshing housing parts, which are firmly connected to one another by means of at least one welded connection. The two housing parts are or will be braced against each other in the radial direction prior to the formation of the at least one welded connection by forming a press fit.

The ball and socket joint according to the present invention makes it possible in a simple manner to carry out a stored-energy welding process to form the at least one welded connection, wherein the process temperature at the weld can be reached because of the rapid rise in the electric welding current before harmful heating of the surrounding material takes place. Stored-energy welding is based, in particular, on the parameters welding force and energy or electric current, the welding force being applied according to the present invention by the radial bracing or prestressing between the two housing parts.

A first of the housing parts preferably has a recess, with which meshes a second of the housing parts with a meshing area. The bracing can be brought about, e.g., by the external diameter of the meshing area of the second housing part being greater before the meshing of the two housing parts than the internal diameter of the recess of the first housing part. The at least one welded connection is then formed especially between the outer jacket surface of the engaging area and the inner wall of the recess. The recess and/or the meshing area are preferably of a cylindrical shape.

To define the position of the at least one weld, at least one projection, at which the press fit is formed, can extend radially at the site of meshing of the two housing parts from an outer jacket surface of one of the housing parts to an inner jacket surface of another of the housing parts. The at least one welded connection will then be formed during welding at the at least one projection. In particular, the at least one projection and/or the at least one welded connection is formed between the axial ends of the inner jacket surface and may have an axial distance from these ends.

The at least one projection extends especially continuously around or is annular, so that the at least one welded connection is likewise designed as a circumferential connection and preferably forms a seal, which prevents dirt and moisture from entering.

The inner jacket surface may form the inner wall of the recess and the outer jacket surface may form the outer jacket surface of the meshing area. Furthermore, a plurality of projections, preferably two, may extend radially from the outer jacket surface to the inner jacket surface and be arranged at spaced locations, especially at axially spaced locations from one another. The projections are especially of identical design and may extend circumferentially continuously. An especially circumferential welded connection is then preferably formed between the two housing parts during the welding process. Furthermore, the projections and/or the welded connections are preferably arranged between the axial ends of the inner jacket surface and may have an axial distance from these ends.

The housing parts consist, e.g., of a weldable metal, preferably steel or special steel. Since it is possible to weld corrosion-protected individual parts, one of the housing parts or both housing parts can be provided fully or partially with a corrosion protection or coated, especially already before welding, so that the joint is protected from corrosion after welding. For example, a ZnNi and/or ZnFe coating, which can be applied to the individual parts or housing parts especially by electroplating, is suitable for use as a corrosion protection.

Furthermore, the projection or projections may be made in one piece with the meshing area, especially already before welding, and adjoin the inner wall of the recess in the mounted state of the joint, so that the second housing part is manufactured especially by machining, e.g., turning. By contrast, the second housing part may be designed as an extruded part. As an alternative or in addition, it is possible to form the projection or projections or some of them in one piece with the first housing part, especially already before welding, and this projection or these projections adjoins/adjoin the jacket surface of the meshing area in the mounted state of the joint. The projection or projections can contribute to the meshing area and/or the recess not having an ideal cylindrical shape any more. However, since the radial extension of each projection is preferably much smaller than the external diameter of the meshing area and/or than the internal diameter of the recess, one continues to speak of a cylindrical shape or an essentially cylindrical shape of the meshing area and/or of the recess. The radial extension of the individual projections may be different in the non-mounted state of the housing parts.

Axially next to the projection or projections, the inner wall of the recess and the outer jacket surface of the meshing area preferably have a radial distance from one another, so that a direct contact occurs between the two housing parts especially only by means of the projection or projections. Since a resistance welding method, especially stored-energy welding, is used to form the welded connection, each projection forms an electrical resistor for the welding current and is heated such that a welded connection is formed between the housing parts at the particular projection.

The bearing shell may consist of a plastic, e.g., POM (polyoxymethylene) or PEEK (polyether ether ketone) and is made especially in one piece or in one part. In particular, the bearing shell has on the inside a hollow spherical surface or partial hollow spherical surface, which is slidingly in contact with the spherical surface or partial spherical surface of the bearing area. The hollow spherical surface or partial hollow spherical surface of the bearing shell may extend in the axial direction beyond a great circle or equator located on the spherical surface or partial spherical surface of the bearing area and be in contact, in particular, with the spherical surface or partial spherical surface of the bearing area axially on both sides of this great circle.

The bearing shell preferably has on the outer circumference at least one radially outwardly extending collar, which is pressed axially between the housing parts. The bearing shell can be secured as a result against tilting and twisting, which prevents the bearing shell from tilting or twisting relative to the housing. The collar is preferably designed as a circumferential, especially as a continuously circumferential collar here.

Furthermore, the bearing shell may have on the outside at least one spherical surface or partial spherical surface, which is in contact, in particular, with at least one inner hollow spherical surface or partial hollow spherical surface of the housing. The housing preferably has two inner partial hollow spherical surfaces that are in contact with the bearing shell and are provided at the housing parts on the inside.

If low moments of friction are required, the housing parts (housing halves) may be manufactured with a ball center offset. Defined small friction radii are thus possible by means of partially elevated prestresses. The ball center offset can be achieved, e.g., by the inner partial hollow spherical surfaces of the housing parts having a different curvature at least prior to the mounting of the joint than the at least one outer spherical surface or partial spherical surface of the bearing shell.

The bearing shell is preferably prestressed via the two housing parts, which can be embodied especially by axial (e.g., hydraulic or pneumatic) pressing of the two housing parts against each other. The housing parts can be tightly connected or welded to one another during this pressing, e.g., by stored-energy welding (SE welding). The rigidity of the joint and the torques can be brought about with very narrow dispersions via the force-controlled prestressing introduced.

The bearing area of the joint inner part is preferably mounted slidingly in the bearing shell. Furthermore, the joint inner part may be designed as a pivot pin, which has a junction area and extends out of the housing on one side. One of the housing parts may be designed in this case as a closing cover or closing ring of the ball and socket joint. However, the joint inner part preferably has two junction areas and extends out of the housing on mutually opposite sides, and the joint inner part is provided with a continuous recess, which passes through the two junction areas and through the bearing area, which is arranged between the two junction areas, so that a ball sleeve joint is formed by the ball and socket joint.

A sealing bellows each may be provided between the housing and the junction area or junction areas in order to prevent dirt and moisture from entering into the interior of the joint. The one or more sealing bellows can be connected to the housing via one or more sheet metal rings vulcanized into the respective sealing bellows, so that cost-effective cold-pressed parts can be obtained as housings without additional processing.

Furthermore, the present invention pertains to a process for manufacturing a ball and socket joint with a housing, with a joint inner part, which is seated in the housing, extends out of this and is mounted movably, especially rotatably and/or pivotably in the housing with a bearing area having a spherical surface or partial spherical surface via the intermediary of a bearing shell, which said housing has two housing parts, which are caused to mesh with one another and are then welded to one another. The housing parts are braced against each other in the radial direction prior to welding to form a press fit, which preferably takes place simultaneously with the meshing of the two housing parts with one another. Since this ball and socket joint is especially a ball and socket joint according to the present invention, it can be varied according to all the embodiments mentioned.

A first of the housing parts preferably has a recess, into which a second of the housing parts is pressed with a meshing area, whose external diameter is greater before the pressing in than the internal diameter of the recess. Furthermore, the two housing parts can be braced against one another axially prior to or during welding, so that a desired prestress can be formed in the joint or the bearing shell. In particular, the two housing parts are welded together by a resistance welding process, e.g., stored-energy welding.

The welding force is usually applied to the parts to be welded together (in the direction of the male die) by a welding machine for stored-energy welding (SE welding machine), and the ST welding machine may have a male die movable in the direction of the male die to apply the force. However, it is possible in the process according to the present invention to use the SE welding machine only to apply the defined prestress in the joint or the prestress of the bearing shell, the welding force resulting especially from the overlap (press fit) of the two housing parts or joined parts. The term overlap is defined here especially as the circumstance that the recess of the first housing part has a smaller diameter than the meshing area of the second housing part prior to the meshing of the two housing parts. The meshing or second housing part, which can also be designed as a closing cover or as a closing ring, is then pressed with an overlap into the receiving housing part or first housing part, and the strength of the connection is obtained as a function of the overlap.

The present invention offers an alternative manufacturing concept with a cost advantage. Furthermore, functional parameters of the joint can be set (e.g., prestress in the joint). The process is also a robust and reliable one, and the housing parts can be manufactured with relatively great tolerances.

The present invention will be described below on the basis of a preferred embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cross-sectional view of one embodiment of the ball and socket joint according to the present invention;

FIG. 2 is an isolated and enlarged view of a first housing part according to FIG. 1 before mounting the joint; and

FIG. 3 is an isolated and enlarged view of a second housing part according to FIG. 1 before mounting the joint.

### DESCRIPTION OF THE PREFERRED EMBODIMENTS

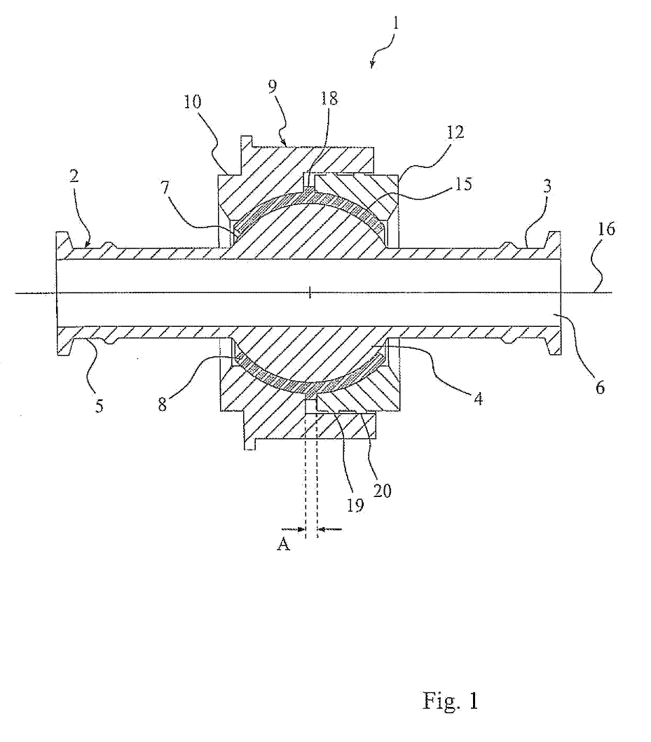

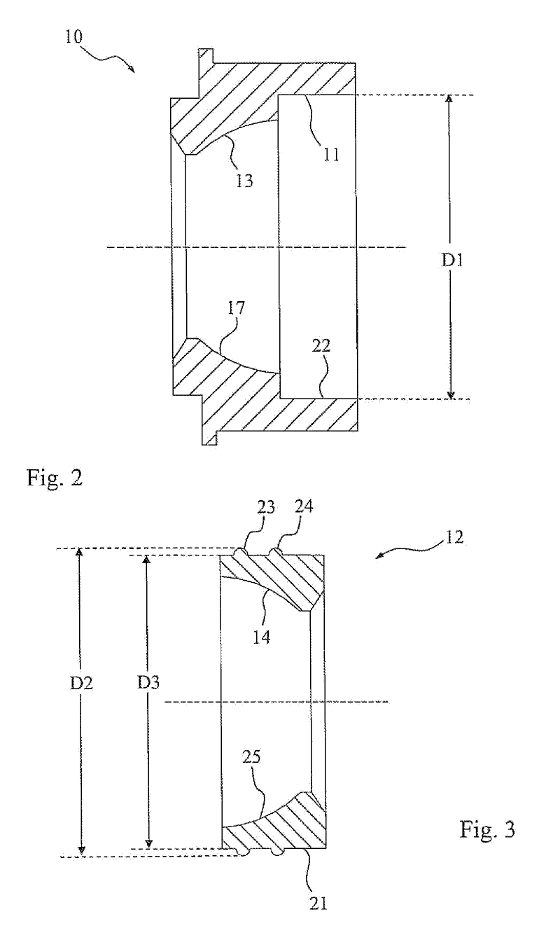

Referring to the drawings in particular, FIG. 1 shows a sectional view of an embodiment of the ball and socket joint 1 according to the present invention, which is designed as a ball sleeve joint and has a joint inner part formed as a ball sleeve 2 with a first junction area 3, with a bearing area 4, with a second junction area 5 and with a continuous recess 6. Bearing area 4 is arranged between the two essentially cylindrical junction areas 3 and 5 and is made in one piece with these. Furthermore, bearing area 4 has a partially spherical outer bearing surface 7, with which it is mounted slidingly in a bearing shell 8, which is seated in a housing 9. Housing 9 is of a two-part design and has a first housing part 10 with a cylindrical recess 11 (see FIG. 2) and a second housing part 12, which meshes with the recess 11 of the first housing part 10.

The housing parts 10 and 12 have a respective partial hollow spherical housing inner surface 13, 14 (see FIGS. 2 and 3), with which a partial hollow spherical outer surface 15 of the bearing shell 8 is in contact. The housing inner surfaces 13, 14 define a partial hollow spherical recess 17, 25 each (see FIGS. 2 and 3) in housing 9. In the direction of the central longitudinal axis 16 of the ball and socket joint 1, the two housing parts 10 and 12 have a distance A from one another, with which a radially outwardly extending collar 18 of the bearing shell 8 meshes, which said collar is of a circumferential design and is pressed axially between the two housing parts 10, 12. The second housing part 12 is fastened to the first housing part 10 via two annular welded connections 19, 20, which connect the outer jacket surface 21 (see FIG. 3) of the second housing part 12 to the inner wall 22 (see FIG. 2) of recess 11.

FIGS. 2 and 3 show sectional views of the first housing part 10 and of the second housing part 12 before mounting, wherein two radially outwardly extending projections or elevations 23, 24, which extend continuously around, i.e., in a ring-shaped manner, are provided on the outer jacket surface 21 of said housing parts. The external diameter D2 of the projections 23, 24 is greater than the internal diameter D1 of recess 11 before the second housing part 12 is inserted into the cylindrical recess 11 of the first housing part 10. Outside of and axially next to the projections 23, 24, the outer jacket surface 21 of the second housing part 12 is of a cylindrical shape and has a diameter D3, which is smaller than or equal to the internal diameter D1 of the cylindrical recess 11. The projections or elevations 23, 24 are made in one piece with the second housing part 12.

To mount the ball and socket joint 1, the second housing part 12 is pressed into recess 11 while the projections 23, 24 are deformed, so that these [projections] are in contact with the inner wall 22 of recess 11 under a radial prestress. Aside from the projections 23, 24, there is, in particular, no direct contact between the two housing parts 10, 12. After pressing in, the welding operation is carried out by means of stored-energy welding, while the radial projections 23, 24 form resistors for the welding current and are heated such that the welded connections 19, 20, which firmly connect the two housing parts 10, 12 to one another, are formed at the radial projections 23, 24.

The external diameter D2 of the projections 23 and 24 is not identical in the preferred embodiment. To attain a uniform pressing pressure between the first housing part 10 and the second housing part 12, the external diameter of the inner projection 23 is made slightly smaller than the external diameter of the axially outer projection 24. Uniform widening of the cylindrical recess 11 in the first housing part 10 is thus achieved during the pressing-in operation, so that a uniform pressing pressure is obtained at both projections 23, 24.

While specific embodiments of the invention have been shown and described in detail to illustrate the application of the principles of the invention, it will be understood that the invention may be embodied otherwise without departing from such principles.

### LIST OF REFERENCE NUMBERS

1 Ball and socket joint

2 Ball sleeve

3 Junction area

4 Bearing area

5 Junction area

6 Continuous recess in the ball sleeve

7 Bearing surface of the bearing area

8 Bearing shell

9 Housing

10 First housing part

11 Cylindrical recess in first housing part

12 Second housing part

13 Housing inner surface

14 Housing inner surface

15 Outer surface of bearing shell

16 Longitudinal axis of ball and socket joint

17 Partial hollow spherical recess of first housing part

18 Collar on bearing shell

19 Welded connection

20 Welded connection

21 Outer jacket surface of second housing part

22 Inner wall of cylindrical recess

23 Projection

24 Projection

25 Partial hollow spherical recess of second housing part

A Distance between housing parts

D1 Internal diameter of cylindrical recess

D2 External diameter of the projections

D3 Diameter of the outer jacket surface

1. A ball and socket joint for a vehicle, the ball and socket joint comprising:
a housing
a joint inner part, which is seated in the housing, extends out of the housing and is mounted movably in the housing said joint inner part having a bearing area having a spherical surface or partial spherical surface
a bearing shell provided as an intermediary between said housing and said joint inner part, said housing having two housing parts, which mesh with one another and are firmly connected to one another by means of at least one welded connection, the two housing parts being braced against one another in the radial direction, forming a press fit, before the at least one welded connection is formed.

2. A ball and socket joint in accordance with claim 1, wherein at least one projection, at which the at least one welded connection is formed, extends radially from an outer jacket surface of one of the housing parts to an inner jacket surface of another of the housing parts at the site at which the two housing parts mesh with one another.

3. A ball and socket joint in accordance with claim 2, wherein at least one second projection, at which a second welded connection is formed, extends radially from the outer jacket surface to the inner jacket surface at the site at which the two housing parts mesh with one another, the two welded connections being located at axially spaced locations from one another.

4. A ball and socket joint in accordance with claim 2, wherein the at least one welded connection comprises a continuous circumferential welded connection.

5. A ball and socket joint in accordance with claim 1, wherein the at least one welded connection is arranged between the axial ends of the inner jacket surface and is located at axially spaced locations from ends thereof.

6. A ball and socket joint in accordance with claim 1, wherein the bearing shell made in one piece has a radially outwardly extending collar on the outer circumference, which said collar is pressed axially between the housing parts.

7. A ball and socket joint in accordance with claim 1, wherein the housing has a hollow spherical surface or partial hollow spherical surface on the inside and the bearing shell has a spherical surface or partial spherical surface on the outside, which is in contact with the hollow spherical surface or partial hollow spherical surface of the housing.

8. A ball and socket joint in accordance with claim 1, wherein the joint inner part has two junction areas and extends from the housing on mutually opposite sides, wherein the joint inner part is provided with a continuous recess, which extends through the two junction areas and through the bearing area, which is arranged between the two junction areas.

9. A process for manufacturing a ball and socket joint with a housing, with a joint inner part, which is seated in the housing, extends from the housing and is mounted movably in the housing with a bearing area having a spherical surface or partial spherical surface via the intermediary of a bearing shell, which said housing has two housing parts, the process comprising the steps of:
meshing the housing parts with one another; and
welding the housing parts together, wherein the meshing includes bracing the housing parts against one another in the radial direction before welding to form a press fit.

10. A process in accordance with claim 9, wherein the housing parts are braced against one another in the radial direction while they are being caused to mesh with one another.

11. A process in accordance with claim 9, wherein a first of the housing parts has a recess, into which a second of the housing parts is pressed with a meshing area, whose external diameter is greater than the internal diameter of the recess before the pressing in.

12. A process in accordance with claim 9, wherein the two housing parts are axially braced against one another before and during welding.

13. A process in accordance with claim 9, wherein the two housing parts are welded together by stored-energy welding.

14. A ball and socket joint for a vehicle, the ball and socket joint comprising:
a housing comprising a first housing part having a partial hollow spherical recess and an adjacent internal cylindrical recess with an inner jacket surface having an internal dimension and a second housing part having a partial hollow spherical recess and an outer cylindrical jacket surface with a shape complementary to said internal cylindrical recess and with an external dimension equal to or smaller than said internal dimension of said internal cylindrical recess, said second housing part further having an annular press fit projection extending radially outwardly from said outer jacket surface to provide an outer projection surface dimension that is grater than said internal dimension of said internal cylindrical recess;
a bearing shell with an inner surface and with a radially outer surface in contact with said first housing part partial hollow spherical recess and said second housing part partial hollow spherical recess; and
a joint inner part seated in the housing bearing shell with an inner surface and extending out of said housing, said joint inner part having a bearing area with a spherical surface or partial spherical surface mounted movably in said bearing shell, said second housing part being outer cylindrical surface being inserted into said internal cylindrical recess with said annular press fit projection forming a press fit connection with said internal cylindrical recess with said second housing part being braced against said first housing part in the radial direction and with said bearing shell radially outer surface in contact with said first housing part partial hollow spherical recess and said second housing part partial hollow spherical recess and with said bearing area mounted movably in said bearing shell; and
a weld connection between said first housing part and said second housing part, said weld connection being formed after forming said press fit connection.

15. A ball and socket joint in accordance with claim 14, wherein said weld connection extends radially from said outer jacket surface to said inner jacket surface at a site of said annular press fit projection.

16. A ball and socket joint in accordance with claim 15, further comprising a second annular press fit projection extending radially outwardly from said outer jacket surface and another weld connection extending radially from said outer jacket surface to said inner jacket surface at a site of said second annular press fit projection, said another weld connection being axially spaced from said weld connection.

17. A ball and socket joint in accordance with claim 15, wherein said weld connection is a continuous circumferential weld connection.

18. A ball and socket joint in accordance with claim 15, wherein said weld connection is arranged between axial ends of the inner jacket surface located at axially spaced locations from said ends.

19. A ball and socket joint in accordance with claim 15, wherein said bearing shell is an integral single piece with a radially outwardly extending collar on the radially outer surface, said collar being pressed axially between said first housing part and said second housing part.

20. A process in accordance with one of the claim 16, wherein each of said weld and said another weld are formed by stored-energy welding.
